(19) United States
(12) Patent Application Publication
(10) Pub. No.: US 2016/0174478 A1
(43) Pub. Date: Jun. 23, 2016

(54) AUTONOMOUS IRRIGATION DEVICE, IN PARTICULAR FOR POT PLANTS

(71) Applicant: PARROT, Paris (FR)

(72) Inventors: Guillaume Pinto, Paris (FR); Vincent Bihler, Paris (FR)

(21) Appl. No.: 14/950,971

(22) Filed: Nov. 24, 2015

(30) Foreign Application Priority Data
Dec. 19, 2014 (FR) 14 62931

(51) Int. Cl. A01G 27/00; A01G 27/02

(52) U.S. Cl. CPC A01G 27/003; A01G 27/02; A01G 27/008

(57) ABSTRACT

This device comprises: a main body (100, 400); a tip (200, 110) adapted to be stuck into a plant substrate; an end fitting (404) opening upward from the body, adapted to tightly and removably cooperate with an opening of a water tank (B), an axis of the end fitting being substantially aligned with a median axis of the tip; humidity detection elements (202a, 202b) provided on the tip; an irrigation control circuit (700) connected to said detection elements; and an irrigation valve (300) provided in the main body, adapted to control a circulation of water between the end fitting (404, 405) and a water outlet passage (406) in response to instructions coming from the irrigation control circuit.

The present invention generally relates to the devices for irrigating plants, in particular pot plants, from a water reserve.

Irrigation accessories for pot plants are already known, which comprise a base to be stuck into the soil of the pot, and a female thread intended to receive a bottle of the PET disposable bottle type, filled with water and turned upside down. A dosing device (low-section duct, porous material) allows to dose the quantity of water added to the soil.

Such an accessory is for example described in the CN 201 107 957 Y.

Such accessories are available on the market from many decades. They effectively allow to ensure a slow irrigation and to eliminate the operations of manual watering. Furthermore, they do not require the creation of an irrigation network, always liable to be blocked, to leak or to go wrong.

They are however incapable of assuring that the water supply is adapted to the plant type, to the pot size, to the ambient atmosphere, etc.

Otherwise, “smart” devices are known, which comprise a tapered base adapted to be stuck into the soil of the pot and a head provided with electronic circuits. The Flower Power product marketed by Parrot SA, Paris, France, allows in particular to remote transmit the needs in water of a pot plant based on a determination of the rate of humidity in the soil. However, such a device is not an irrigation accessory, it requires a regular manual intervention to carry out the irrigation itself, according to the instructions given by the device.

The KR 101 045 740 B1 describes an automatic irrigation network, where each pot is provided with a valve mounted in a block able to stuck into the soil, the valve being connected to a remote pump and a common water tank. A control circuit connected to a photoelectric cell and to a humidity sensor controls the opening and the closing of the valve and the intake of water from the pressurized distribution network as a function of the plant needs. This system is however relatively complex, it requires the installation of a water distribution network and is therefore not adapted to the irrigation of an isolated plant.

The present invention aims to improve the known irrigation devices and to propose a device of the type using a bottle filled with water and turned upside down, a device that, while remaining simple and easy to use, is autonomous and able to ensure an automation of the water distribution dosing.

Another object of the invention is to propose such a device that requires no pumping means, and that can hence be power supplied by a battery or cell of very low capacity for a long duration.

Still another object of the invention is to propose a device that can support a significant water reserve while remaining stable.

Indeed, the interest of such a device lies in the possibility for a user to be absent during several days, or even several weeks, with the certainty that everything will happen as planned and that the plant will be correctly irrigated.

The stability of such a device after it has been stuck into the soil of the pot is in this regard an essential point; as the device should not, over time, tilt to one side and fall down, in particular after an irrigation sequence having for effect to loosen the soil. This risk is increased by the fact that, if the user is absent for long, in hot season, etc., it will have placed a bottle of high capacity and fully filled it, so that the weight of the system will be able to reach 2 kg. Now, due to the raised position of the bottle and to the weight thereof, the centre of gravity of the accessory+bottle+water content system is located far above the level of the soil in the pot, which makes the system very unsteady and increases the risk of falling down.

The invention proposes for that purpose an irrigation device for plants of the generic type disclosed in the above-mentioned CN 201 107 957 Y, i.e. comprising, in a manner known per se: a main body; a tip adapted to be stuck into a plant substrate; an end fitting opening upward from the body and adapted to tightly and removably cooperate with an opening of a bottle placed upside down, forming a water tank; and an irrigation means provided in the main body, adapted to control a circulation of water between the end fitting and a water outlet passage.

Characteristically of the invention, the device further comprises humidity detection elements provided on the tip and an irrigation control circuit connected to the detection elements. The tip comprises a generally planar and sharp blade-shaped part, locally coated with said detection elements, an axis of the end fitting being substantially aligned with a median axis of the blade-shaped part. The irrigation means comprises an irrigation valve controllable in response to instructions from the irrigation control circuit, so that the water flows from the water reserve to go out through the water outlet passage and fall into the substrate.

According to various advantageous subsidiary characteristics:
the blade-shaped part is a printed circuit, which carries in particular the irrigation control circuit;
the tip includes a stiffening dement fastened to the blade on the two faces thereof, the main body and the stiffening element defining in particular together an external contour that is generally continuous and that widens from the bottom to the top;
the device further comprises a photoelectric sensor connected to the irrigation control circuit and arranged in an upper part of the main body;
the water outlet passage opens at an inclined upper surface of the main body, vertically aligned with a point-shaped low end of said upper surface;
the end fitting comprises a cylindrical part made of an elastomeric material, having at least two different diameters to tightly fit into the mouth of a standard disposable bottle and provided with a water inlet orifice, the water outlet passage being in particular arranged in the vicinity of a base of said end fitting, the valve having a dosing part arranged at least partially inside the end fitting;
a wireless communication circuit for the reception of irrigation parameters is associated with the irrigation control circuit.

An exemplary embodiment of the invention will now be described, with reference to the appended drawings in which the same references denote identical or functionally similar dements throughout the figures.

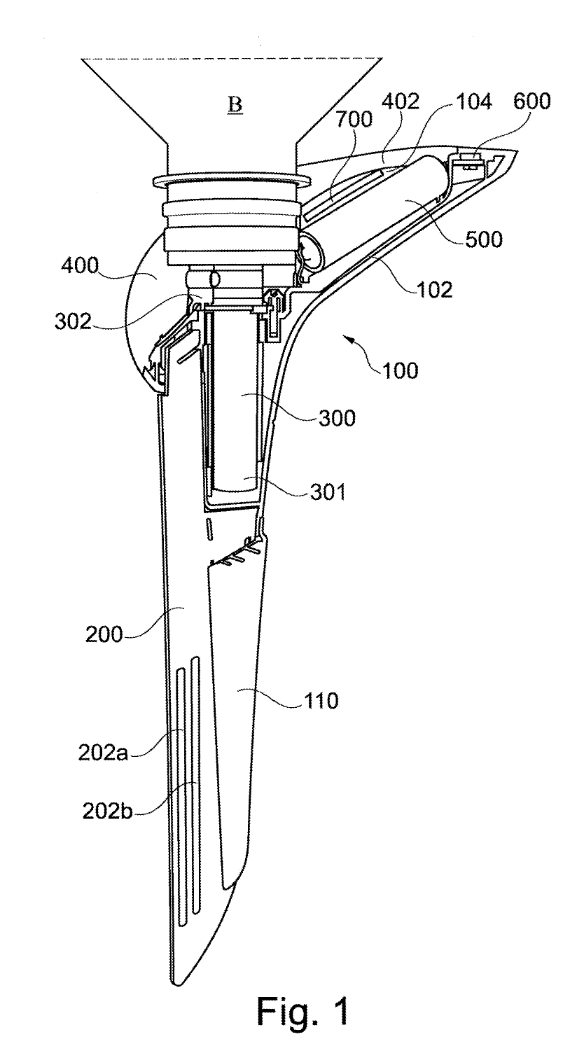

FIG. 1 is a partially cut-away perspective view of a device according to the invention.

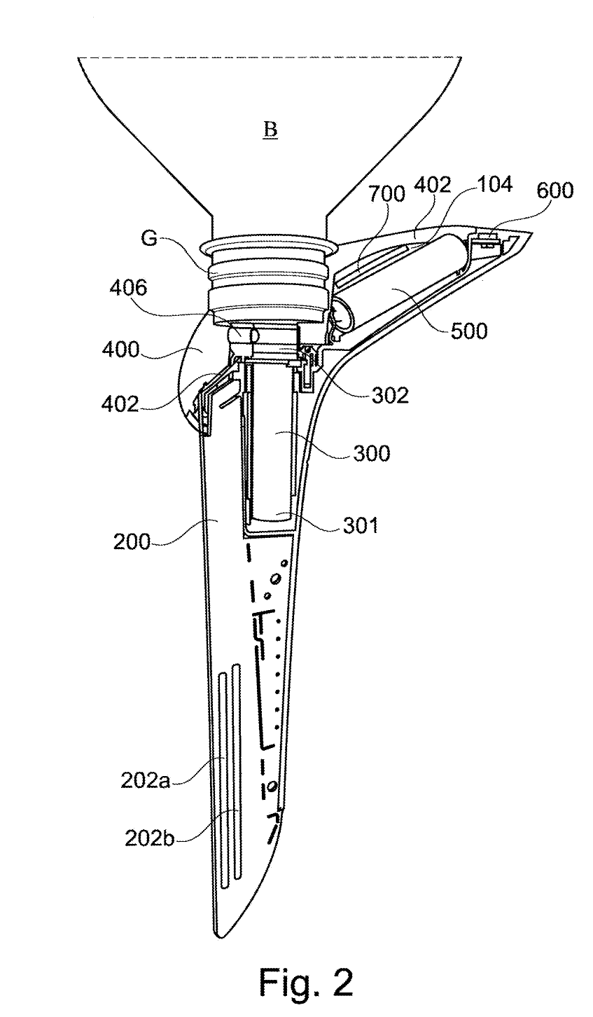

FIG. 2 is a perspective view similar to FIG. 1, with a part removed.

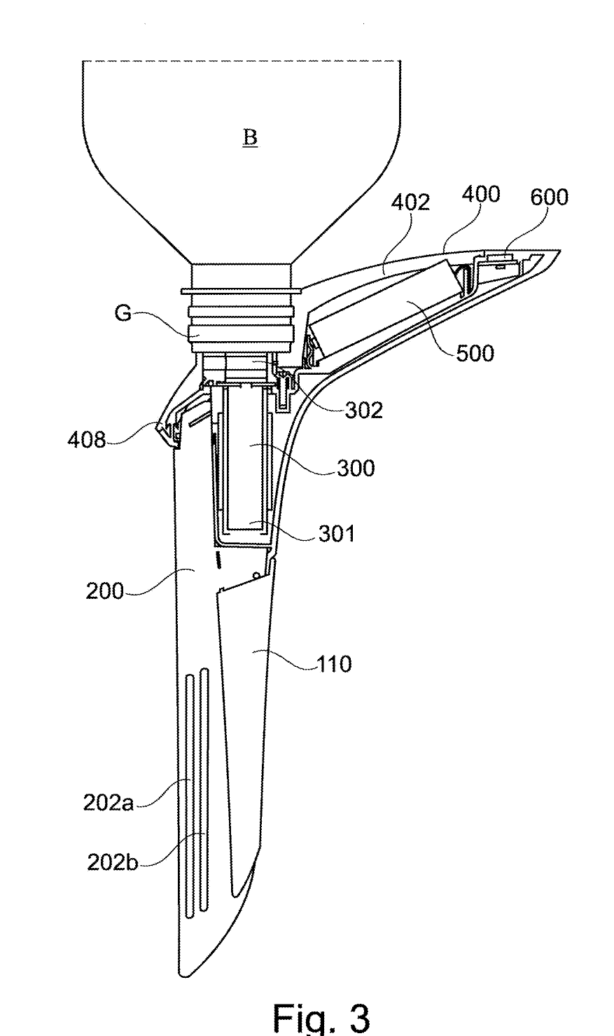

FIG. 3 is a side elevation view, in partial cross-section, of the device.

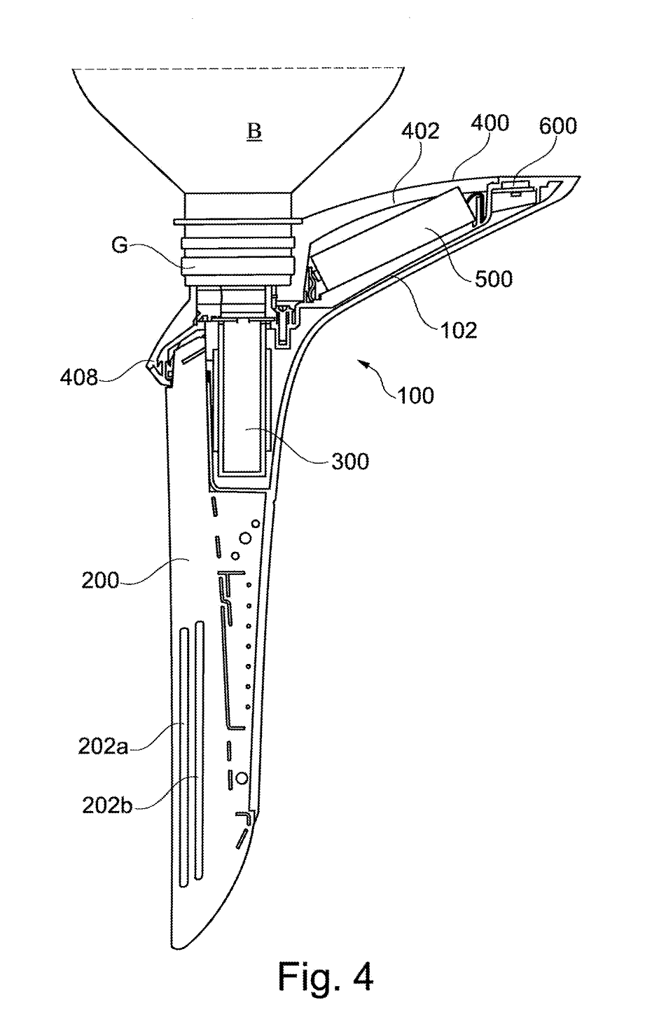

FIG. 4 is a side elevation view similar to FIG. 3, with a part removed.

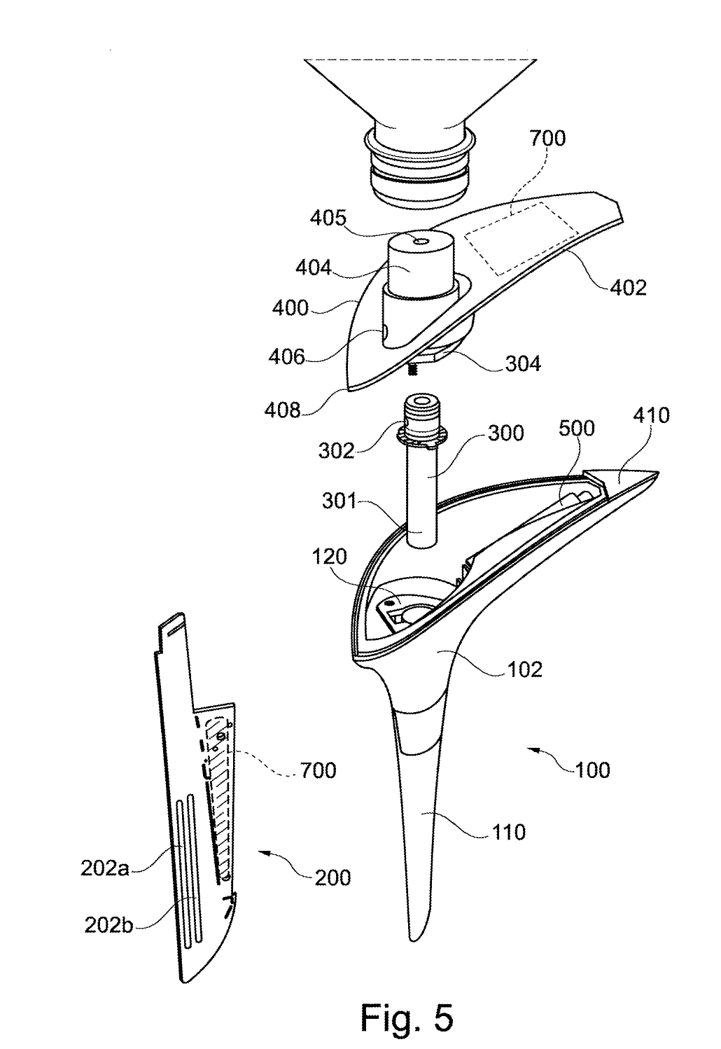

FIG. 5 is an exploded perspective view of the device.

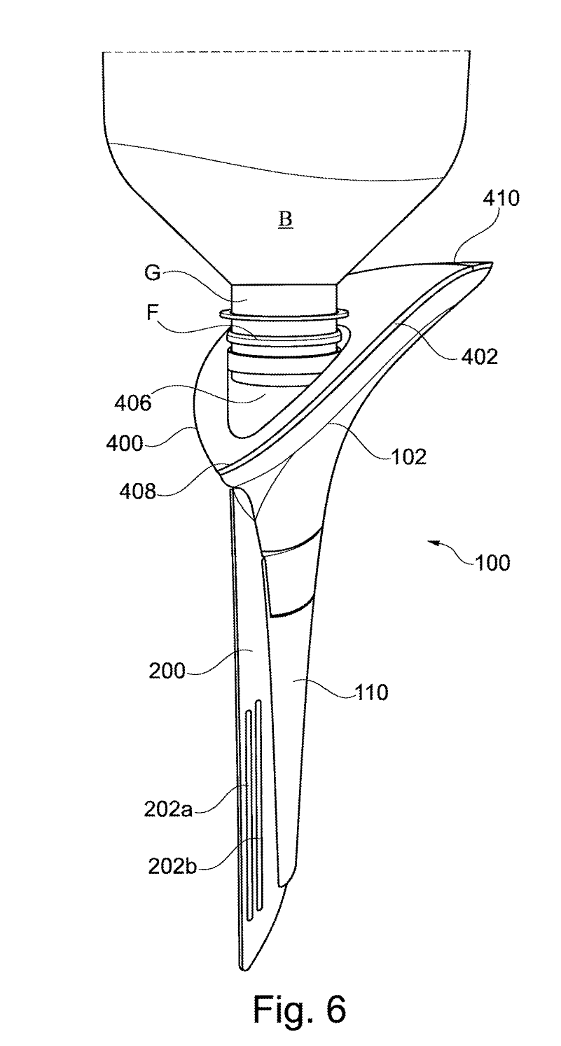

FIG. 6 is a face and profile perspective view of the device, and

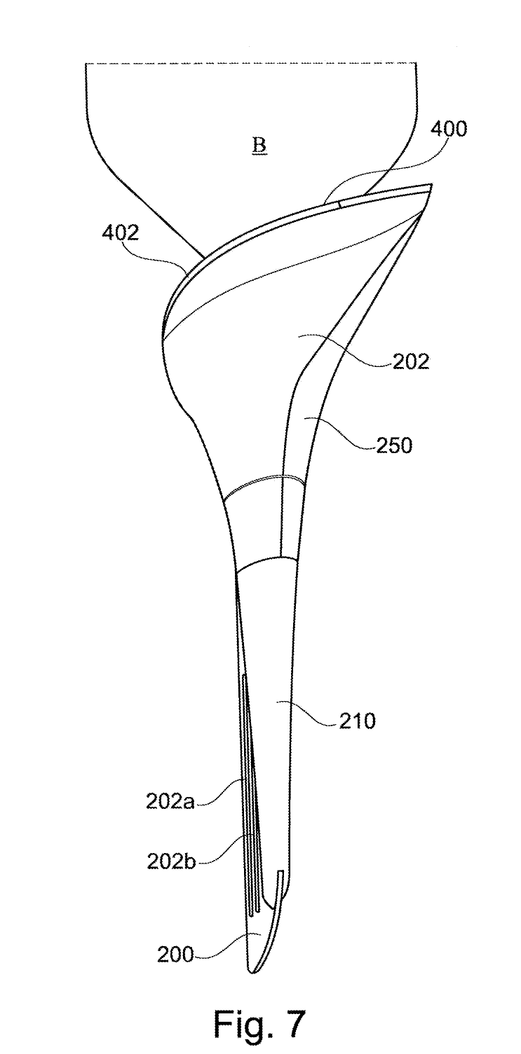

FIG. 7 is a profile and rear perspective view of the device.

With reference to the drawings, an automatic irrigation device according to the invention comprises a generally hollow main body 100, having a curved wall 102 defining a cavity 104.

The main body has a generally oblique and inclined upper face, and its horizontal section progressively narrows downward, down to an essentially continuous region of transition with a generally tapered secondary body 110, of generally semi-circular cross section and narrowing downward.

A sabre-shaped blade 200, having for example a thickness of 1 to 3 mm, is fastened to the main body 100 and to the secondary body 110 by any suitable fixation technique. This blade is consisted by a printed circuit including measurement electrodes, with two external electrodes 202a and 202b used to measure the salinity of the ambient medium, and an internal electrode incorporated to the printed circuit (not visible) to measure the rate of humidity in combination with one of the two external electrodes.

As observed in the Figures, the secondary body 110 extends along the blade 200 by being fixed to the latter on the two faces thereof and by catching the rear edge thereof, to hence play the role of a mechanical reinforcement.

As a variant, the secondary body 110 may be made directly on the blade 200, for example by being over-moulded on the two faces of the latter. A particularly suitable material is the Macromelt (registered trademark) of the Henkel Company, Germany.

The main body 100 houses an electromagnetic valve 300 oriented generally vertically, with an upper part 302 of a control body 301 cooperating with a closing part 304 of the conventional type per se (flap, etc.). It will be noted, as seen in FIG. 5, that the control body 301 of the valve 300 is partially received in the part of the body 100 that forms the transition with the secondary body 110, a sealing gasket 120 being preferably about the body 301 in its region.

The curved and oblique top of the main body 100 is closed by a lid 400 having a main wall 402 from which protrudes upward, vertically aligned with the valve 300, an end fitting 404 of connection with a water tank. This end fitting 404 is adapted to receive the mouth G of a PET bottle placed upside down, the mouth being forcibly inserted into the end fitting 404.

This end fitting 404 has the shape of a generally cylindrical body made of an elastomeric material, slightly narrowing upward, by having at least two different diameters to tightly fit into the mouth of a standard PET disposable bottle, hence avoiding any screwing action.

The elastomeric-material end fitting 404 is made for example by being over-moulded on the part 400, or is tightly engaged on a tubular core (not visible) formed single-piece with the part 400.

The part 400 is fastened to the main body 100, for example by peripheral ultrasonic welding.

This end fitting includes at the apex thereof a water inlet orifice 405, of small size, exposed to the water contained in the bottle B, and opening laterally in the vicinity of its base, a water outlet passage 406. The dosing part 304 of the valve 300 is arranged inside the end fitting 400 and is adapted to selectively allow or forbid the passage of the water at the inlet orifice 405 and the outlet passage 406, by an “all or nothing” control of the valve 300, the logic of which will be detailed hereinafter.

As observed in the figures, the axis of the end fitting 404 of connection with the water reserve B is essentially aligned with the blade 200 reinforced by the secondary body 110.

The device further comprises an electronic control circuitry 700, a photoelectric cell 600 arranged in the generally point-shaped upper part of the main body 100, and a battery 500. In order for the cell 600 to be exposed to the ambient light, the lid 400 includes, vertically aligned with it, a transparent window 410.

The electronic circuitry 700 is mounted on an integrated electronic board at any desired place of the device. Advantageously and as illustrated in FIG. 5, it is integrated directly on the blade 200, made with the printed circuit technology, in which case the secondary body 110 is tightly assembled to the blade 200 and advantageously plays the role of protective lid for the electronic components. This approach facilitates the connection of the electrodes 202a, 202b with the electronic circuitry, these elements being located on the same support consisted by the blade 200.

As a variant, this option being also illustrated in FIG. 5, the electronic cart 700 is mounted in a suitable support in the cavity 104 defined by the body, for example along the battery 500.

The electronic circuitry 700 is advantageously provided with a wireless communication circuit, for example according to the Bluetooth standard, so as to be able to communicate with a remote smart equipment such as a “smartphone” or a tactile tablet.

The use and operation of the device of the invention will now be described.

A battery being placed in the cavity 104 of the main body 100 (accessible by a conventional door, not illustrated), the device is tightly mounted at the end fitting 404 of a water reserve, herein consisted of a PET bottle without its plug, previously filled with water, possibly added with soluble fertilizer.

A small hole may if necessary be made in the region of the bottle B located opposite the mouth G to allow the entry of air as the bottle empties.

The system being oriented as illustrated in the figures, the part formed by the blade 200 and the secondary body 110 is stuck into the substrate (potting soil, earth, sand, various mixtures) of a pot inhabited by a plant, up to a level located in the vicinity of the transition between the main body 100 and the secondary body 110, or above this transition.

It will be observed herein that the combination between the flared shape of the body 100, 110 and the fact that the axis of the end fitting 404 is aligned with a median axis of the blade 200 allows to provide the system with an excellent stability, even with a reserve consisted of a PET bottle of a capacity of 2 litres when fully filled.

The device is then started via an ON/OFF button, or by automatic detection of the sticking into the substrate.

The control circuitry may, previously or at the time of this starting, be programmed from a “smartphone” or a tactile tablet to be able to deliver a quantity of water adapted to the plant type, to the pot size, etc.

The irrigation calculation circuits may be of the same type as those of the Flower Power product marketed by the Parrot Company mentioned in the introduction, which comprises lighting, humidity, temperature and fertilizer concentration measurement sensors, and a processor for processing the data produced by these sensors and for determining the water needs as a function of the plant type, so that the data exploited within the framework of use of this product may be advantageously reused.

The irrigation control cycle is advantageously based on any combination of the following parameters:
the exposure to light, allowing for example to determine the hour of the day without the use of an internal clock;
the rate of humidity in the substrate, determined by the electrodes 202a, 202b connected to the circuit of estimation of humidity provided in the electronic circuitry;
the plant type, remote programmed;
the pot size, remote programmed;
any other useful parameter, either remote indicated by the wireless communication circuit, or directly measured in the device (for example, ambient temperature, humidity of the ambient air, quantity of nutritive materials in the substrate, etc.).

When, in response to the irrigation control strategy defined, the valve 300 is controlled by the electronic circuitry 700 to cause an irrigation of the substrate, the water flows from the reserve B, via the inlet orifice 405 and the closing part 304, to go out at the passage 406 and flow, along the top of the wall 402, down to its point-shaped low end 408, to fall from there into the substrate.

A closing of the valve 300 in response to the control strategy stops the flow of water.

Moreover, a sensor may be provided, for example associated with the outlet passage 406, indicating to the control circuitry that the water reserve B is empty. This circuitry is then preferably able to signal to a smartphone or a tablet of the user, via the wireless communication circuit, that the reserve has to be refilled.

1. An irrigation device for plants, in particular pot plants, of the type comprising:
a main body (100, 400);
a tip (200, 110) adapted to be stuck into a plant substrate;
an end fitting (404) opening upward from the body and adapted to tightly and removably cooperate with an opening of a bottle placed upside down, forming a water tank (B); and
an irrigation means (300) provided in the main body, adapted to control a circulation of water between the end fitting (404, 405) and a water outlet passage (406),
the device being characterized in that:
it further comprises humidity detection elements (202a, 202b) provided on the tip and an irrigation control circuit (700) connected to the detection elements;
the tip comprises a generally planar and sharp blade-shaped part (200), locally coated with said detection elements (202a, 202b), an axis of the end fitting (404) being substantially aligned with a median axis of the blade-shaped part (200); and
the irrigation means comprises an irrigation valve (300) controllable in response to instructions from the irrigation control circuit, so that the water flows from the water reserve (B) to go out through the water outlet passage (406) and to fall into the substrate.

2. The device of claim 1, wherein the blade-shaped part (200) is a printed circuit.

3. The device of claim 2, wherein the printed circuit (200) carries the irrigation control circuit (700).

4. The device of claim 1, wherein the tip includes a stiffening element (110) fastened to the blade (200) on the two faces thereof.

5. The device of claim 4, wherein the main body (100) and the stiffening element (110) define together an external contour generally continuous and widening from the bottom to the top.

6. The device of claim 1, further comprising a photoelectric sensor (600) connected to the irrigation control circuit (700) and arranged in an upper part of the main body (100).

7. The device of claim 1, wherein the water outlet passage (406) opens at an inclined upper surface (402) of the main body, vertically aligned with a point-shaped low end (408) of said upper surface.

8. The device of claim 1, wherein the end fitting (404) comprises a cylindrical part made of an elastomeric material, having at least two different diameters to tightly fit into the mouth of a standard disposable bottle and provided with a water inlet orifice (405).

9. The device of claim 8, wherein the water outlet passage (406) is arranged in the vicinity of a base of said end fitting (404) and the valve has a dosing part (304) arranged at least partially inside the end fitting.

10. The device of claim 1, wherein a wireless communication circuit for the reception of irrigation parameters is associated with the irrigation control circuit.
